(19) United States
(12) Patent Application Publication
(10) Pub. No.: US 2010/0057404 A1
(43) Pub. Date: Mar. 4, 2010

(54) Optimal Performance and Power Management With Two Dependent Actuators

(75) Inventors: Gero Dittmann, New York, NY (US); Alper Buyuktosunoglu, White Plains, NY (US); Indira Nair, Briarcliff Manor, NY (US); Reinaldo A. Bergamaschi, Tarrytown, NY (US)

Correspondence Address: MICHAEL J. CHANG, LLC, 84 SUMMIT AVENUE, MILFORD, CT, 06460, US

(73) Assignee: International Business Machines Corporation, Armonk, NY (US)

(21) Appl. No.: 12/201,877

(22) Filed: Aug. 29, 2008

(51) Int. Cl. G06F 19/00; G05B 13/02

(52) U.S. Cl. 702/186; 700/28

(57) ABSTRACT

Techniques for processor chip power management and performance optimization are provided. In one aspect, a method for maximizing performance of a processor chip within a given power consumption budget is provided. The method comprises the following steps. A power consumption and performance of the processor chip at all possible voltage level and frequency combinations is predicted. The processor chip is adjusted to the voltage level and frequency combination that provides the highest performance while having a power consumption that does not exceed the power budget. After a time interval t₁, the frequency of the processor chip is varied to accommodate for any shift in workload to maintain the highest performance within the power budget. After a time interval t₂, the adjust and vary steps are repeated, wherein time interval t₂ is greater than time interval t₁.

### STATEMENT OF GOVERNMENT RIGHTS

This invention was made with Government support under Contract number HR00110790002 awarded by (DARPA) Defense Advanced Research Projects Agency. The Government has certain rights in this invention.

### FIELD OF THE INVENTION

The present invention relates to processor chips, and more particularly, to techniques for processor chip power management and performance optimization.

### BACKGROUND OF THE INVENTION

Power management features are common in today's high-power computing devices to conserve power and are especially useful in devices, such as laptop computers, that run on batteries. One way to conserve power is to modulate processor activity, which is typically enabled through the use of power management actuators, such as dynamic frequency scaling (DFS) or combined frequency and voltage scaling (DVFS) actuators, that scale-down processor frequency and/or voltage at certain times or in certain modes. By temporarily reducing processor activity, heat produced by the device is also reduced, thereby further conserving power needed for cooling.

In conventional systems, power management actuators, such as DVFS actuators, are typically used to vary the voltage and frequency at which the processor is run to accommodate for changes in computing workload and so as to maintain a particular power consumption budget. Such voltage and frequency changes can only be instituted at a certain frequency to ensure proper operation of the processor. Namely, a proper amount of time must be allotted between voltage changes, for example, to allow for voltage step-down and regulation. However, during this time period, the workload on the processor likely will have already changed, and as such, the processor will be operating at a sub-optimal level.

Therefore, techniques that maximize processor performance within the confines of a given power budget would be desirable.

### SUMMARY OF THE INVENTION

The present invention provides techniques for processor chip power management and performance optimization. In one aspect of the invention, a method for maximizing performance of a processor chip within a given power consumption budget is provided. The method comprises the following steps. A power consumption and performance of the processor chip at all possible voltage level and frequency combinations is predicted. The processor chip is adjusted to the voltage level and frequency combination that provides the highest performance while having a power consumption that does not exceed the power budget. After a time interval t₁, the frequency of the processor chip is varied to accommodate for any shift in workload to maintain the highest performance within the power budget. After a time interval t₂, the adjust and vary steps are repeated, wherein time interval t₂ is greater than time interval t₁.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for maximizing performance of a processor chip within a given power consumption budget according to an embodiment of the present invention;

FIG. 2 is a graph illustrating voltage level/maximum frequency pairs for a particular set of workloads according to an embodiment of the present invention; and

FIG. 3 is a diagram illustrating an exemplary apparatus for maximizing performance of a processor chip within a given power consumption budget according to an embodiment of the present invention.

### DETAILED DESCRIPTION OF PREFERRED EMBODIMENTS

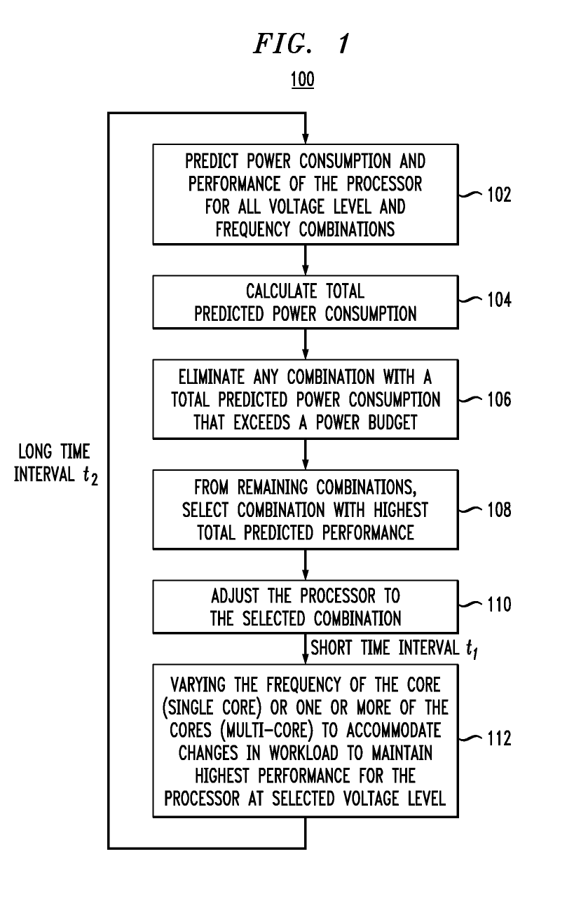

FIG. 1 is a diagram illustrating exemplary methodology 100 for maximizing performance of a processor chip within a given power consumption budget. The processor chip can be a single core processor chip or a multi-core processor chip. Methodology 100 can be implemented using standard frequency and voltage scaling (DVFS) actuators which, as will be described in detail below, are configured to change voltage levels and/or frequencies on a per-core or chip-wide basis.

In step 102, power consumption and performance of the processor chip are predicted for each possible voltage level in combination with each possible frequency. The voltage level and frequency can be equated with power consumption using a power management tool, such as MaxBIPS. See, for example, C. Isci et al., “An Analysis of Efficient Multi-Core Global Power Management Policies: Maximizing Performance for a Given Power Budget,” Proceedings of the 39^{th} annual International Symposium on Microarchitecture (MICRO' 06), IEEE, pp. 347-358 (Dec. 9-13, 2006) (hereinafter “Isci”), the disclosure of which is incorporated by reference herein. For example, as described in Isci, MaxBIPS predicts power and billion instructions per second (BIPS) values for different combinations of power (voltage (Vdd)/frequency (f)) modes, i.e., full-throttle execution (Vdd, f), medium power savings (95 percent (%) Vdd, 95% f) and high power savings (85% Vdd, 85% f), and chooses the combination with the highest throughput that meets a power budget. As further described in Isci, with combined frequency and voltage scaling, power has a cubic relation to frequency and voltage scaling, and performance has a relatively linear dependence on frequency. As highlighted above, the voltage level and/or frequency can be varied on a per-core or a chip-wide basis. According to an exemplary embodiment, the voltage level is varied on a chip-wide basis, while the frequency is varied on a per-core basis (in the case of a multi-core processor chip). Therefore, when the processor chip is a multi-core processor chip, in step 102 the power consumption and performance of each of the cores can be predicted for all possible chip-wide voltages in combination with all possible frequencies for each individual core. By way of example only, step 102 can be carried out by first selecting a particular voltage level and then varying the frequencies available (for the single core or for each core in a multi-core configuration) for that particular voltage level. This process can be systematically repeated to obtain all possible voltage level/frequency combinations.

Core performance is a measure of throughput. According to an exemplary embodiment, performance is measured as the number of instructions executed per second. As will be described in detail below, performance can vary as a function of workload distribution.

Each core reports its actual power consumption and performance at regular measurement intervals. The predicted power consumption and performance can be obtained by extrapolating from the actual power consumption and performance data. For example, at any given point in time, the power consumption and performance for each core can be predicted by extrapolating from data collected at the last measurement interval. See, for example, R. Bergamaschi et al., “Exploring Power Management in Multi-Core Systems,” Proceedings of the 13^{th} Asia and South Pacific Design Automation Conference (ASP-DAC 2008), Seoul, Korea (January 2008) (wherein when voltage (v) and frequency (f) mode (v, f) is set as (v′, f′), performance (I) is predicted as

$$I * ( \frac{{f}^{′}}{f} ) ,$$

dynamic power (P) is predicted as

$$P * {( \frac{{v}^{′}}{v} )}^{2} * ( \frac{{f}^{′}}{f} )$$

and static power (L) is predicted as

$$L * {( \frac{{v}^{′}}{v} )}^{3} ( approx . ) ,$$

and wherein the total power is the sum of static and dynamic power), the disclosure of which is incorporated by reference herein.

In step 104, a total predicted power consumption is determined for each of the voltage level/frequency combinations. With a multi-core processor chip, the total predicted power consumption is the sum of the predicted power consumption values for each of the cores. With a single core processor chip, the total predicted power consumption is simply the predicted power consumption value for the single core. Once the total predicted power consumption is determined for each voltage level/frequency combination, in step 106, any voltage level/frequency combination that results in a total predicted power consumption that is greater than the given power budget is eliminated. A power budget is generally established, e.g., by a system administrator, and might not be a physical limit, but more of a power usage guideline, that if adhered to, can help control operating costs.

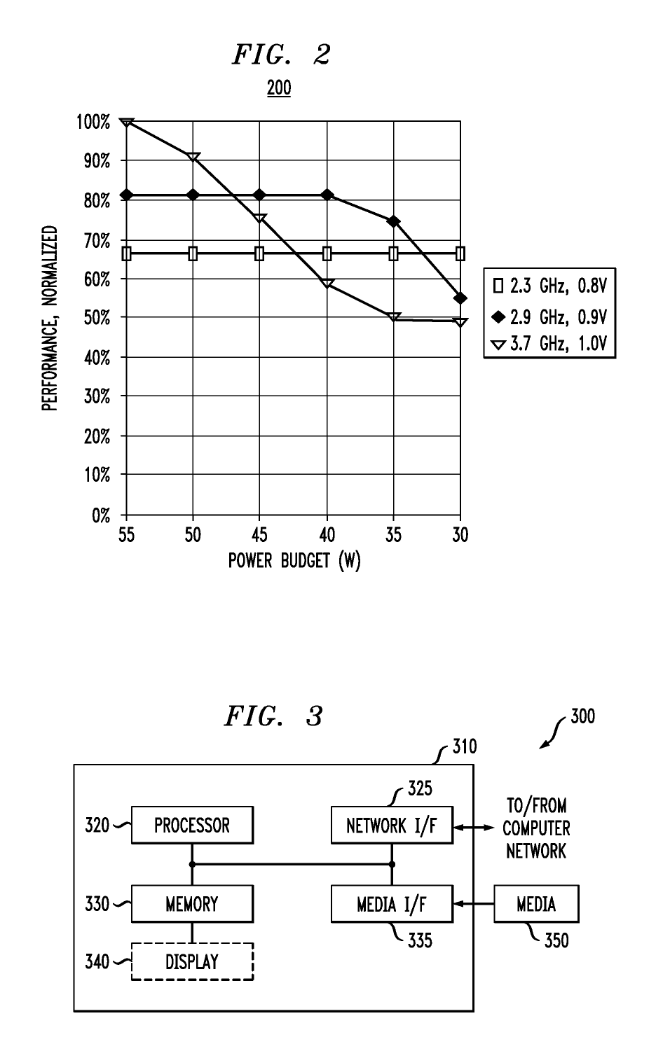

In step 108, from the voltage level/frequency combinations that remain (i.e., those voltage level/frequency combinations with a total predicted power consumption that meets (is less than or equal to) the power budget), the voltage level/frequency combination that provides the highest predicted performance for the processor chip is selected. With a multi-core processor chip, the total predicted performance is the sum of the predicted performance values for each of the cores. With a single core processor chip, the total predicted performance is simply the predicted performance value for the single core. This selection process is shown graphically in FIG. 2, below. As highlighted above, the performance of the core(s) can vary as a function of workload distribution during operation of the processor chip. In this step, processor chip performance is maximized by selecting the voltage level/frequency combination that provides the highest performance. The voltage level selected in this step will determine the maximum frequency for the core(s), both in this step and in steps 110-112, described below. Namely, for a given voltage there is only a certain range of frequencies that can be implemented as each frequency requires a certain minimum voltage.

In step 110, the processor chip is adjusted to the voltage level/frequency combination selected in step 108, above. This voltage level/frequency combination will, within the confines of the given power budget, maximize performance of the processor chip (i.e., across all of the cores in the case of a multi-core configuration), for at least the current operating conditions.

The current operating conditions may change before the next step of methodology 100, step 112, is carried out. Thus, after a time interval t₁, in step 112, the frequency of the core (in a single core configuration) or one or more of the cores (in a multi-core configuration) is varied to accommodate for any shift in the workload. This is done to again optimize the total performance of the processor chip given the workload change. In a multi-core configuration, the workload can shift among the cores. For example, one or more of the cores that were actively performing computations might now be stalled due to memory accesses, while one or more of the other cores might now be more active.

The frequency now chosen for each core can again be based on the core power consumption and performance predictions made in step 102, above. As highlighted above, the frequencies chosen in this step are limited to the frequencies that can be implemented for the voltage level selected in step 108 (described above).

As highlighted above, the voltage level and frequency of the processor chip can be adjusted using standard DVFS actuators. According to an exemplary embodiment, two DVFS actuators are employed, one to adjust the voltage level and another to adjust the frequency. The DVFS actuators can be configured to adjust the voltage level and/or frequency on a per-core basis or on a chip-wide basis. For example, the DVFS actuators can be configured to adjust the voltage level and the frequency on a per-core basis (e.g., in the case of a multi-core processor chip). Alternatively, the DVFS actuators can be configured to adjust the voltage level on a chip-wide basis and the frequency on a per-core basis (e.g., in the case of a multi-core processor chip). Further, the DVFS actuators can be configured to adjust both the voltage level and the frequency on a chip-wide basis (for both single core and multi-core processor chips).

The present techniques take advantage of the notion that the processor chip can cope with more frequent changes in frequency than in voltage. Therefore, methodology 100 has two invocation intervals, a shorter interval (i.e., time interval t₁) for frequency changes and a longer interval (i.e., time interval t₂, see below) for combined voltage level and frequency changes. This approach enables a more frequent performance optimization than would be achieved if the voltage level and frequency were only changed at the same time, resulting in higher performance.

After a time interval t₂, the steps of methodology 100 are repeated. As highlighted above, time interval t₂ is longer than time interval t₁, due to the processor chip being able to accommodate more frequent changes in frequency than in voltage level. Time intervals t₁ and t₂ can be predetermined and set by a system administrator. By way of example only, time interval t₁ can have a duration of about 50 microseconds (μs) and time interval t₂ can have a duration of about two milliseconds (ms). It is to be understood that these time interval values are merely exemplary and other time interval values may be employed, as long as the time interval for frequency changes, i.e., time interval t₁, is shorter than the time interval for voltage level changes, i.e., time interval t₂.

FIG. 2 is graph 200 illustrating voltage level/maximum frequency pairs for a particular set of workloads. Namely, in graph 200, core performance is plotted as a function of power budget (measured in Watts (W)). The legend in graph 200 gives the maximum frequency for the associated voltage level. As shown in graph 200, the particular voltage level/maximum frequency combination that provides the highest performance depends on the power budget. Namely, to meet the power budget the frequency is reduced along a curve, reducing power consumption, while the voltage is fixed for each curve. By way of example only, for a power budget greater than about 47 W a chip voltage level of one volt (V) is selected enabling a maximum core frequency of 3.7 gigahertz (GHz), for a power budget of from about 47 W to about 33 W a chip voltage level of 0.9 V is selected enabling a maximum core frequency of 2.9 GHz and for a power budget of less than about 33 W a chip voltage level of 0.8 V is selected enabling a maximum core frequency of 2.3 GHz. Using this selection process, a core performance at the top of the set of the curves shown in graph 200 can be achieved.

Turning now to FIG. 3, a block diagram is shown of an apparatus 300 for maximizing performance of a processor chip within a given power consumption budget, in accordance with one embodiment of the present invention. The processor chip can be local or remote to apparatus 300. It should be understood that apparatus 300 represents one embodiment for implementing methodology 100 of FIG. 1.

Apparatus 300 comprises a computer system 310 and removable media 350. Computer system 310 comprises a local processor 320, a network interface 325, a memory 330, a media interface 335 and an optional display 340. Network interface 325 allows computer system 310 to connect to a network, while media interface 335 allows computer system 310 to interact with media, such as a hard drive or removable media 350.

As is known in the art, the methods and apparatus discussed herein may be distributed as an article of manufacture that itself comprises a machine-readable medium containing one or more programs which when executed implement embodiments of the present invention. For instance, the machine-readable medium may contain a program configured to predict a power consumption and performance of the processor chip at all possible voltage level and frequency combinations; adjust the processor chip to the voltage level and frequency combination that provides the highest performance while having a power consumption that does not exceed the power budget; after a time interval t₁, vary the frequency of the processor chip to accommodate for any shift in workload to maintain the highest performance within the power budget; and after a time interval t₂, repeat the adjust and vary steps, wherein time interval t₂ is greater than time interval t₁.

As highlighted above, the voltage level and frequency of the processor chip can be adjusted using one or more standard DVFS actuators. Thus, by way of example only, apparatus 300 can control one or more DVFS actuators (not shown) and by way thereof implement one or more of the steps of methodology 100.

The machine-readable medium may be a recordable medium (e.g., floppy disks, hard drive, optical disks such as removable media 350, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Local processor 320 can be configured to implement the methods, steps, and functions disclosed herein. The memory 330 could be distributed or local and the local processor 320 could be distributed or singular. The memory 330 could be implemented as an electrical, magnetic or optical memory, or any combination of these or other types of storage devices. Moreover, the term “memory” should be construed broadly enough to encompass any information able to be read from, or written to, an address in the addressable space accessed by local processor 320. With this definition, information on a network, accessible through network interface 325, is still within memory 330 because the local processor 320 can retrieve the information from the network. It should be noted that each distributed processor that makes up local processor 320 generally contains its own addressable memory space. It should also be noted that some or all of computer system 310 can be incorporated into an application-specific or general-use integrated circuit.

Optional video display 340 is any type of video display suitable for interacting with a human user of apparatus 300. Generally, video display 340 is a computer monitor or other similar video display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for maximizing performance of a processor chip within a given power consumption budget, comprising the steps of:
predicting a power consumption and performance of the processor chip at all possible voltage level and frequency combinations;
adjusting the processor chip to the voltage level and frequency combination that provides the highest performance while having a power consumption that does not exceed the power budget;
after a time interval t₁, varying the frequency of the processor chip to accommodate for any shift in workload to maintain the highest performance within the power budget; and
after a time interval t₂, repeating the adjusting and varying steps, wherein time interval t₂ is greater than time interval t₁.

2. The method of claim 1, further comprising the step of:
at a given measurement interval, collecting power consumption and performance data from the processor chip.

3. The method of claim 2, further comprising the step of:
extrapolating the power consumption and performance data collected from the processor chip to predict the power consumption and performance of the processor chip at all possible voltage level and frequency combinations.

4. The method of claim 1, wherein the predicting step further comprises the steps of:
selecting a particular voltage level;
varying the available frequencies for the selected voltage level; and
repeating the steps of selecting the particular voltage level and varying the available frequencies to obtain all possible voltage level and frequency combinations.

5. The method of claim 1, wherein the processor chip is a multi-core processor chip and wherein the step of predicting the power consumption and performance of the processor chip further comprises the step of:
predicting a power consumption and performance of each core at all possible voltage level and frequency combinations.

6. The method of claim 5, further comprising the steps of:
calculating a total predicted power consumption for each of the voltage level and frequency combinations;
eliminating any of the voltage level and frequency combinations with a total predicted power consumption that exceeds the given power budget; and
selecting, from the remaining voltage level and frequency combinations, the voltage level and frequency combination with a highest total predicted performance for the processor chip.

7. The method of claim 5, wherein the processor chip is a multi-core processor chip and wherein the step of varying the frequency of the processor chip further comprises the step of:
at the time interval t₁, varying the frequency of one or more of the cores to accommodate for any shift in workload among the cores to maintain the highest predicted performance for the processor chip within the given power budget.

8. The method of claim 1, wherein the processor chip is a multi-core processor chip and wherein the step of predicting the power consumption and performance of the processor chip further comprises the step of:
predicting a power consumption and performance of each core at all possible voltage level and frequency combinations, wherein the voltage level is determined on a chip-wide basis and the frequency is determined on a per-core basis.

9. An apparatus for maximizing performance of a remote processor chip within a given power consumption budget, the apparatus comprising:
a memory; and
at least one local processor, coupled to the memory, operative to:
predict a power consumption and performance of the remote processor chip at all possible voltage level and frequency combinations;
adjust the remote processor chip to the voltage level and frequency combination that provides the highest performance while having a power consumption that does not exceed the power budget;
after a time interval t₁, vary the frequency of the remote processor chip to accommodate for any shift in workload to maintain the highest performance within the power budget; and
after a time interval t₂, repeat the adjust and vary steps, wherein time interval t₂ is greater than time interval t₁.

10. The apparatus of claim 9, wherein the at least one local processor is further operative to:
at a given measurement interval, collect power consumption and performance data from the remote processor chip.

11. The apparatus of claim 10, wherein the at least one local processor is further operative to:
extrapolate the power consumption and performance data collected from the remote processor chip to predict the power consumption and performance of the remote processor chip at all possible voltage level and frequency combinations.

12. The apparatus of claim 9, wherein the remote processor chip is a multi-core processor chip and wherein the at least one local processor, operative to predict the power consumption and performance of the remote processor chip, is further operative to:
predict a power consumption and performance of each core at all possible voltage level and frequency combinations.

13. The apparatus of claim 12, wherein the at least one local processor is further operative to:
calculate a total predicted power consumption for each of the voltage level and frequency combinations;
eliminate any of the voltage level and frequency combinations with a total predicted power consumption that exceeds the given power budget; and
select, from the remaining voltage level and frequency combinations, the voltage level and frequency combination with a highest total predicted performance for the remote processor chip.

14. The apparatus of claim 12, wherein the remote processor chip is a multi-core processor chip and wherein the at least one local processor, operative to vary the frequency of the remote processor chip, is further operative to:
at the time interval t₁, vary the frequency of one or more of the cores to accommodate for any shift in workload among the cores to maintain the highest predicted performance for the processor chip within the given power budget.

15. An article of manufacture for maximizing performance of a processor chip within a given power consumption budget, comprising a machine-readable medium containing one or more programs which when executed implement the steps of:
predicting a power consumption and performance of the processor chip at all possible voltage level and frequency combinations;
adjusting the processor chip to the voltage level and frequency combination that provides the highest performance while having a power consumption that does not exceed the power budget;
after a time interval t₁, varying the frequency of the processor chip to accommodate for any shift in workload to maintain the highest performance within the power budget; and
after a time interval t₂, repeating the adjusting and varying steps, wherein time interval t₂ is greater than time interval t₁.

16. The article of manufacture of claim 15, wherein the one or more programs which when executed further implement the step of:
at a given measurement interval, collecting power consumption and performance data from the processor chip.

17. The article of manufacture of claim 16, wherein the one or more programs which when executed further implement the step of:
extrapolating the power consumption and performance data collected from the processor chip to predict the power consumption and performance of the processor chip at all possible voltage level and frequency combinations.

18. The article of manufacture of claim 16, wherein the processor chip is a multi-core processor chip and wherein the step of predicting the power consumption and performance of the processor chip further comprises the step of:
predicting a power consumption and performance of each core at all possible voltage level and frequency combinations.

19. The article of manufacture of claim 18, wherein the one or more programs which when executed further implement the step of:
calculating a total predicted power consumption for each of the voltage level and frequency combinations;
eliminating any of the voltage level and frequency combinations with a total predicted power consumption that exceeds the given power budget; and
selecting, from the remaining voltage level and frequency combinations, the voltage level and frequency combination with a highest total predicted performance for the processor chip.

20. The article of manufacture of claim 18, wherein the processor chip is a multi-core processor chip and wherein the step of varying the frequency of the processor chip further comprises the step of:
at the time interval t₁, varying the frequency of one or more of the cores to accommodate for any shift in workload among the cores to maintain the highest predicted performance for the processor chip within the given power budget.
